(19) United States
(12) Patent Application Publication
(10) Pub. No.: US 2002/0152276 A1
(43) Pub. Date: Oct. 17, 2002

(54) Methods and systems for providing personalized notification

(76) Inventor: David A. Jablow, Somerset, NJ (US)

Correspondence Address: John E. Curtin, Esq., Throutman Sanders Mays & Valentine L.L.P., Suite 600, 1660 International Drive, McLean, VA, 22102, US

(21) Appl. No.: 09/835,376

(22) Filed: Apr. 17, 2001

(51) Int. Cl. G06F 15/16

(52) U.S. Cl. 709/207; 709/206

(57) ABSTRACT

Personalized notifications are sent to individuals to notify them of the results of a particular event, such as a lottery or exam. The notifications are sent by a network linked to both the individuals and an administrator of the event.

### BACKGROUND OF THE INVENTION

Millions of people now use some type of on-line network, such as the Internet, every day. Of these people, most, if not all, also have the need to be reminded or notified of some event. Typically, this event will occur periodically (e.g., daily, monthly, or even hourly). For example, millions of people play government/state-sponsored lotteries on a weekly or daily basis. Some people play the identical number day after day. To date, the most common method of notifying an individual that he or she has won a lottery requires the individual to take some action to determine the results of the lottery (e.g., by buying a newspaper, watching a television, calling a toll-free number or returning to the place where she bought a lottery ticket). None of these methods are tailored to provide results to an individual. Rather, they are designed to provide the same information to a large number of people. In sum, they do not provide a “personalized” way of notifying an individual.

Lotteries are just one example of a periodic activity or event that people may engage in which requires some kind of subsequent notification.

Accordingly, it is a desire of the present invention to provide methods and systems for providing personalized notification to individuals.

Other desires will become apparent from a review of the specification, drawings and claims that follow.

### SUMMARY OF THE INVENTION

In accordance with the present invention there are provided methods and systems for providing personalized notification concerning an “event”.

One such event is a lottery. Others are: a sports or entertainment event, an educational event or an exam, for example.

In each case, a network controller is adapted to receive personal information from a user and administrative information from an administrator responsible for the event.

The personal information comprises many elements, one element being the one or more methods of notification preferred by a user.

At an appropriate point in time the controller is adapted to compare the administrative information (e.g., winning lottery number) to the personal information (e.g., lottery numbers selected by the user) or vice-versa . If a match occurs, the controller is adapted to send a personalized notification to the user according to one of the preferred methods of notification (e.g., by email).

The present invention and its advantages can be best understood by referring to the drawings, detailed description of the invention and claims that follow.

### BRIEF DESCRIPTION OF THE DRAWINGS

FIG. 1 depicts a simplified block diagram of a system for providing personalized notifications according to one embodiment of the present invention.

FIG. 2 depicts one example of an input display which may be used by an individual to enter personal information according to one embodiment of the present invention.

FIG. 3 depicts one example of an input display which may be used by an administrator or the like to enter event-related, administrative information according to one embodiment of the present invention.

FIG. 4 depicts a flow diagram of a sequence of actions which may be used by an individual to enter personal information according to one embodiment of the present invention.

FIG. 5 depicts a flow diagram of a sequence of actions which may be used by an administrator or the like to enter event-related, administrative information according to one embodiment of the present invention.

### DETAILED DESCRIPTION OF THE INVENTION

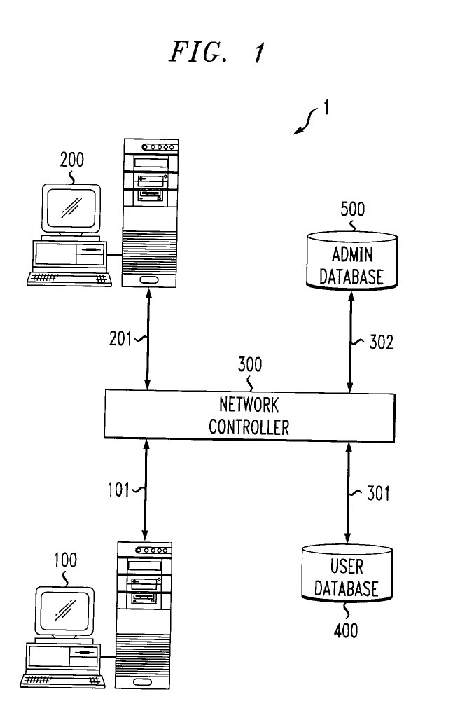

Referring to FIG. 1, there is shown a system 1 for providing personalized notifications to individuals. In an illustrative embodiment of the present invention, the system 1 comprises a user network access unit 100, administrative network access unit 200, a network control unit or controller 300, a user database 400 and an administrative database 500. Though shown as three units, it should be understood that the network controller 300, user database 400 and administrative database 500 may be combined into fewer than three units or further broken down into additional units. Similarly, though typically the user network access unit 100 and administrative network access unit 200 will be separate units, there may be rare cases when the two may be combined into a single unit. For sure, there are times when either the user network access unit 100 or administrative network access unit 200 may be broken down into more than one unit. It should be further understood that system 1 shown in FIG. 1 is highly simplified and may in fact comprise any number of components such as network servers, modems, personal computers, microprocessors, datalinks, electronic memory, and application software, to give just a few examples.

When the network formed by the units 100-500 comprises the World Wide Web, the controller 300 may comprise an Internet server.

In one embodiment of the present invention, the controller 300 comprises a server adapted to receive and send signals to and from the user network access unit 100 and administrative network access unit 200 via pathways 101 and 201. In an illustrative embodiment of the present invention, the system 1 may be adapted to provide personalized notifications to individuals about the results of government/state sponsored lotteries. Typically, the user network access unit 100 comprises a personal computer owned by an individual wishing to participate in a lottery or owned by a retail establishment responsible for distributing and selling lottery tickets. The administrative network access unit 200 may comprise a computer system, private network or personal computer which is adapted to provide the system 1 with event-related, administrative information (hereafter referred to as “administrative information”), such as the winning lottery number for a specific lottery.

When the system 1 is used to notify users about the results of a lottery, the user database 400 comprises a database of information concerning at least the identification of the users participating in a given lottery, each user's preferred method of notification (e.g., by telephone, day or night; by fax; or by email); and the lottery numbers selected by each user. The administrative database 500 comprises a database adapted to store event related information, for example, the winning lottery number for each specific lottery.

It should be understood that lotteries are only one event in which system 1 may be used to provide personalized notifications to participating users. In general, the user network access unit 100 may be adapted to provide personal information input by an individual concerning any number of events while the administrative network access unit 200 may be adapted to provide information which may be incorporated into a notification sent to a user concerning any number of events as well. Similarly, databases 400, 500 may be adapted to store information concerning any number of events.

A more detailed example of the operation of system 1 is as follows.

In one embodiment of the present invention, user network access unit 100 is adapted to receive instructions from a user (not shown). More specifically, the unit 100 is adapted to receive instructions directing it to initiate a link with controller 300. For example, the user may input the address of a website sponsored by a state lottery commission, such as “www.didiwin.com”. Thereafter, the unit 100 is adapted to create a link with controller 300. In response, controller 300 is adapted to send content and formatting information associated with the lottery's website to the user network access unit 100. Upon receiving the content and formatting information, the unit 100 is adapted to display the website to the user. Depending on the sophistication of the website, it may take one or more additional steps for the user to maneuver from page to page within the website to find an input screen. Once such an input screen is found, the user begins to input personal information related to an event, in this case a lottery, she wishes to participate in.

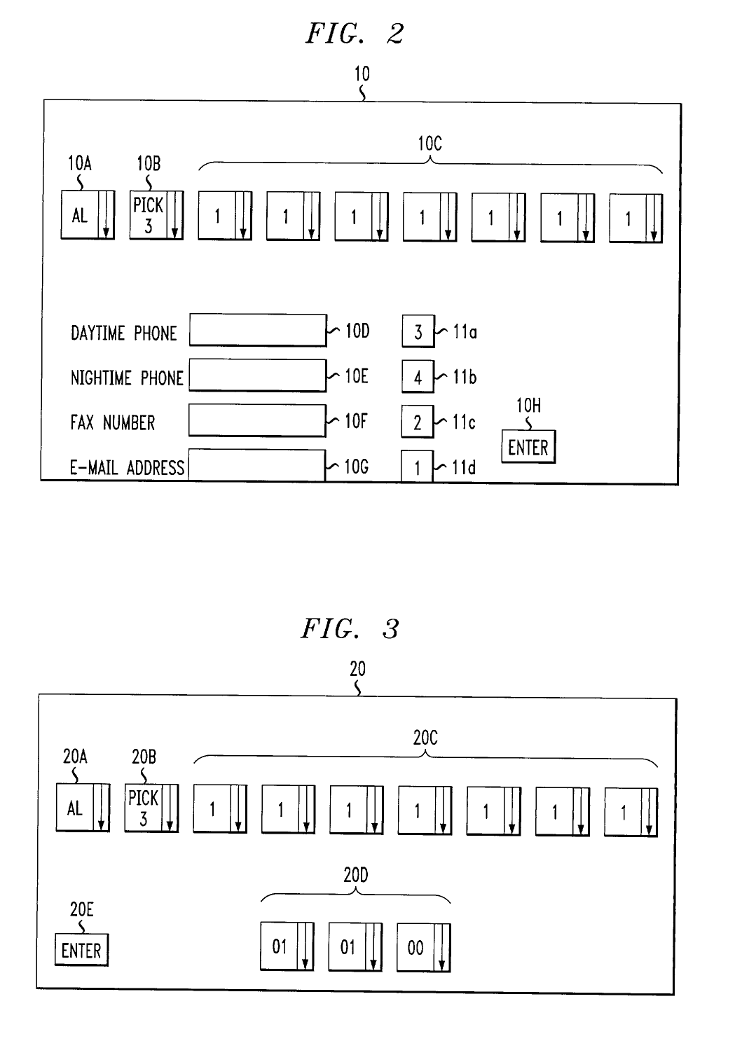

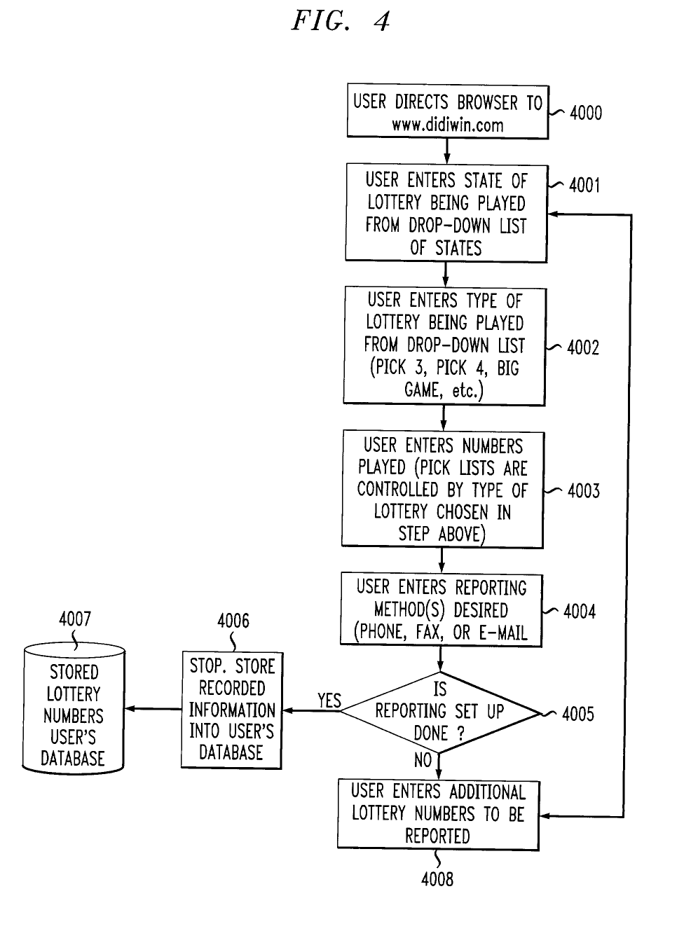

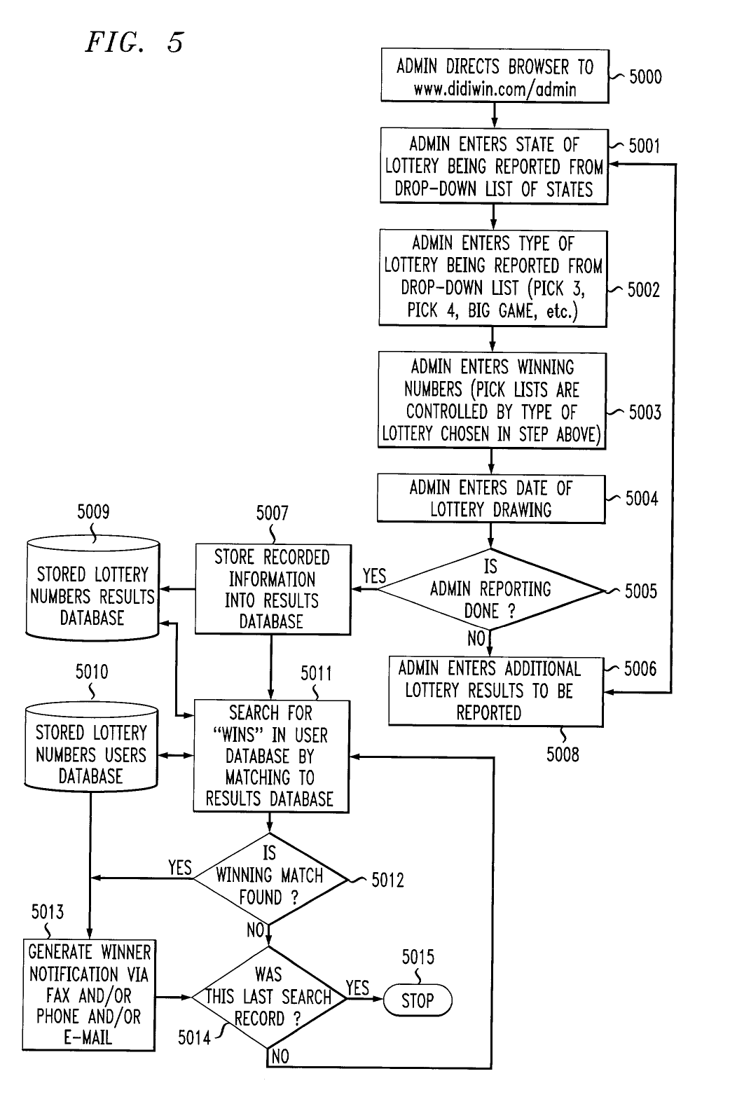

Referring now to FIG. 2, there is shown an example of an event input display 10 used by a user to input personal, event-related information. Once display 10 is shown to the user, the user may proceed in any number of different sequences to input the necessary information. In one embodiment of the present invention, the sequence followed by a user is shown in the flow diagram depicted in FIG. 4.

The user first enters the state or government entity which is sponsoring the lottery via a graphical user interface (e.g., a mouse, keyboard and associated software) (not shown) at position 10a. Display 10 may be adapted to allow a user to select a state or the like from a drop down list of states accessed via position 10a. Next, the user selects the type of lottery or otherwise identifies the lottery she wishes to participate in, or monitor the results of, (collectively referred to as “participate in”) at location 10b. Next to position 10b are positions 10c. In an illustrative embodiment of the present invention, the user inputs a number in each of the positions 10c. This number represents a lottery number. It should be understood that even though FIG. 2 shows position 10c comprising seven digits, the invention is not so limited. Any number of digits may be used which corresponds to a given lottery or event. Also, as with location 10a, locations 10b and 10c may also comprise drop down lists.

In more general terms, positions 10a and 10b function to help identify the specific event while positions 10c allow a user to input “user specific” information relating to a specific event.

In FIG. 2, locations 10d through 10g are adapted to receive one or more preferred notification methods. For example, the user may decide that she prefers to be contacted via her daytime phone 10d, nighttime phone 10e, facsimile number 10f (i.e., telephone and/or facsimile number may be a conventional number, wireless number, or a wireless Internet number), or email address 10g to name just a few. As will be explained in more detail later, this (or these) preferred method(s) of notification will be used to provide a personalized notification to the user if the lottery number she has entered at location 10c matches the winning lottery number (or vice-versa) and/or to notify the user of the winning lottery number even if she has not won.

Alternatively, the user may indicate which method of notification which should be used first to notify her by entering or otherwise indicating a ranking at locations 11a-d (e.g., “1” equals first preferred method, “2” equals second preferred method, etc. . . ). In yet another embodiment, the user may indicate which method may be used by placing a “check” in a location 11a-11d (not shown).

Collectively, all of the information entered by the user can be referred to as personal information.

In one embodiment of the present invention, each time the user inputs information at a specific location 10a through 10g and activates an “enter/send” location 10h or the like, the user network access unit 100 is adapted to send this information to the controller 300.

Upon receiving the information from the user, the controller 300 is adapted to send this information to database 400 which is adapted to store the information.

It should be understood that the display 10 shown in FIG. 2 is only one of many different input displays which may be used to input personal information.

If the user wishes to participate in additional lotteries or events she need only repeat the sequence described above. This continues until the user has input information related to each event of interest to her. After the user is done entering such information she may exit the system 1.

It should be noted that the present invention does not rely upon any specific type of link between the access unit 100 and the controller 300. Many types of links or configurations may be used including: twisted pair (copper) wire, DSL, cable modems, wireless transceivers and the associated cable/telephone/wireless/ISP company equipment needed to complete the link between unit 100 and controller 300.

At some point the event of interest occurs, in this case, a lottery. As envisioned by the present invention, the results of this event or information related to the event is transmitted to the controller 300 by an “administrator”.

In one embodiment of the present invention, the administrative network access unit 200 is adapted to receive instructions from the administrator. These instructions may include a request to create a link with the controller 300. For example, the administrator may enter a special, administrative website address (e.g., www.didiwin.com/admin). Upon receiving a request to create a link with the unit 200, the controller 300 is adapted to send the unit 200 content and formatting information associated with the administrative website. For example, the controller 300 may be adapted to the send content and formatting associated with an administrative input screen 20 shown in FIG. 3.

Before proceeding further, it should be understood that the controller 300 or databases 400, 500 may or may not be adapted to store some of the websites accessed by the user and administrator.

As was the case with the information input by the user, there are many different sequences which can be used by the administrator to enter information into display 20. One such sequence is shown in the flow diagram of FIG. 5.

Referring back to FIG. 3, the administrator may first enter the identity of the state or government responsible for sponsoring a specific lottery or event using a drop down list or the like at location 20a. Next, the administrator may enter the identity of the specific lottery or event at location 20b and the winning lottery number at locations 20c followed by entering the date of the specific lottery or event at locations 20d.

Similar to before, the administrative network access unit 200 can be adapted to send the information input into locations 20a-d to the controller 300 by activating location 20e. Collectively, once again, all of the information input by the administrator can be referred to as administrative information.

It may be that the administrator has the responsibility for more than one lottery or event. In such a case, the administrator repeats the steps mentioned above for each specific lottery or event.

Upon receiving the administrative information from the unit 200, the controller 300 is adapted to send this information to database 500 which is adapted to store it.

What remains is to determine whether there is a relationship between the personal information stored in database 400 and the administrative information stored in database 500. Said another way, staying with the lottery example above, the system 1 must determine whether the winning number entered by the administrator matches the lottery number entered by a user.

In an illustrative embodiment of the present invention, the controller 300 is adapted to select the information supplied by the administrator stored in database 500 and to compare it to the information associated with a given user from database 400. If the controller 300 determines that a match has occurred, or another relevant relationship exists, then the controller 300 may be adapted to generate a personalized message indicating that a match has occurred or a relationship exists. For example, the controller 300 is adapted to generate a message that a user has won the lottery if the winning number matches the user's lottery number.

In yet a further embodiment of the present invention, the controller 300 is adapted to transmit or otherwise send this personalized message to the user network access unit 100 to personally notify the user via one or more of the preferred methods input by the user at locations 10d through 10g (see FIG. 2).

In the event the user has elected to participate in more than one event the controller 300 is adapted to repeat the steps just mentioned, each time forwarding a personalized message to the user according to her preferred methods on detecting the existence of a match or another relationship.

Alternatively, the controller 300 can be adapted to send personalized messages to the access unit 100 informing the user that no match and/or no relationship exists in accordance with a list of preferred notification methods.

Upon completing this process for one user, the controller 300 is adapted to repeat this process using personal information associated with the next user stored in database 400 until the administrative information is compared to each user's personal information.

Though the discussion just ended involves a comparison of the administrative information (e.g.; winning lottery number) to each user's personal information (e.g. user's lottery number) it should be understood that the present invention also envisions the reverse-comparing each user's information to the administrative information. In fact, the word “comparison” or its conjugates (e.g., compare, etc.) is meant to encompass either or both methods.

It should be understood that the units 100-500 may comprise one or more programmed mediums (e.g. memory, magnetic storage device, CD, floppy disk, processor, digital storage device) which comprise one or more software or firmware-like programs adapted to carry out the features and functions of the present invention. When carried out by a program, the programs may initially reside on one unit 100-500 and then be sent (e.g., downloaded) to another unit 100-500.

Again, though the invention above is focused on a system to administer a lottery, the invention is not so limited. The systems and methods described above may also be used to provide personal notifications which confirm/deny a user's registration for a particular event, such as a sports/entertainment event, a professional/educational course/school or other event which otherwise supplies a user with results (e.g., exam results).

Variations on the examples above can be made by those skilled in the art without departing from the sprit and scope of the present invention as defined by the claims which follow.

1. A system for providing personalized notification comprising:
a controller adapted to compare personal information and
administrative information related to an event and further adapted to send a
personalized notification to a user concerning the event.

2. The system as in claim 1 wherein the event is a lottery.

3. The system as in claim 1 wherein the event is a sports or entertainment event.

4. The system as in claim 1 wherein the event is an educational event.

5. The system as in claim 1 wherein the event is an exam.

6. The system as in claim 1 wherein the personal information comprises a preferred method of notification.

7. The system as in claim 1 wherein the controller is further adapted to send the notification via one of the user's preferred notification methods.

8. The system as in claim 7 wherein the controller is further adapted to send the notification via email.

9. The system as in claim 7 wherein the controller is further adapted to send the notification via a daytime telephone number.

10. The system as in claim 7 wherein the controller is further adapted to send the notification via a nighttime telephone number.

11. The system as in claim 7 wherein the controller is further adapted to send the notification via facsimile.

12. The system as in claim 1 wherein the controller comprises a server.

13. The system as in claim 1 wherein the controller comprises an Internet server.

14. The system as in claim 1 further comprising a user database adapted to store the personal information.

15. The system as in claim 1 further comprising an administrative database adapted to store the administrative information.

16. The system as in claim 1 further comprising a user network access unit adapted to send the personal information to the controller.

17. The system as in claim 1 further comprising an administrative network access unit adapted to send the administrative information to the controller.

18. The system as in claim 1 wherein the personal information comprises a lottery number.

19. The system as in claim 1 wherein the administrative information comprises a winning lottery number.

20. A method for providing personalized notification comprising:
comparing personal information and administrative information related to an event; and
sending a personalized notification to a user concerning the event.

21. The method as in claim 20 wherein the event is a lottery.

22. The method as in claim 20 wherein the event is a sports or entertainment event.

23. The method as in claim 20 wherein the event is an educational event.

24. The method as in claim 20 wherein the event is an exam.

25. The method as in claim 20 wherein the personal information comprises a preferred method of notification.

26. The method as in claim 20 further comprising sending the notification via one of the user's preferred notification methods.

27. The method as in claim 26 further comprising sending the notification via email.

28. The method as in claim 26 further comprising sending the notification via a daytime telephone number.

29. The method as in claim 26 further comprising sending the notification via a nighttime telephone number.

30. The method as in claim 26 further comprising sending the notification via facsimile.

31. The method as in claim 20 further comprising storing the personal information.

32. The method as in claim 20 further comprising storing the administrative information.

33. The method as in claim 20 wherein the personal information comprises a lottery number.

34. The method as in claim 20 wherein the administrative information comprises a winning lottery number.

35. A programmed medium adapted to compare personal information and administrative information related to an event and further adapted to send a personalized notification to a user concerning the event.

36. The programmed medium as in claim 35 wherein the event is a lottery.

37. The programmed medium as in claim 35 wherein the event is a sports or entertainment event.

38. The programmed medium as in claim 35 wherein the event is an educational event.

39. The programmed medium as in claim 35 wherein the event is an exam.

40. The programmed medium as in claim 35 wherein the personal information comprises a preferred method of notification.

41. The programmed medium as in claim 35 further adapted to send the notification via one of the user's preferred notification methods.

42. The programmed medium as in claim 41 further adapted to send the notification via email.

43. The programmed medium as in claim 41 further adapted to send the notification via a daytime telephone number.

44. The programmed medium as in claim 41 further adapted to send the notification via a nighttime telephone number.

45. The programmed medium as in claim 41 further adapted to send the notification via facsimile.

46. The programmed medium as in claim 35 further adapted to store the personal information.

47. The programmed medium as in claim 35 further adapted to store the administrative information.

48. The programmed medium as in claim 35 wherein the personal information comprises a lottery number.

49. The programmed medium as in claim 35 wherein the administrative information comprises a winning lottery number.

50. The programmed medium as in claim 35 wherein the medium comprises a CD.

51. The programmed medium as in claim 35 wherein the medium comprises a magnetic storage device.

52. The programmed medium as in claim 35 wherein the medium comprises a digital storage device.
